(19) United States
(12) Patent Application Publication
(10) Pub. No.: US 2026/0299108 A1
(43) Pub. Date: Oct. 1, 2026

(54) RADAR DEVICE AND METHOD FOR ANALYZING RADAR MEASUREMENT SIGNALS FROM A RADAR DEVICE

(71) Applicant: Robert Bosch GmbH, Stuttgart (DE)

(72) Inventors: Daniel Schindler, Korntal-Münchingen (DE); Tobias Schmid, Fluorn-Winzeln (DE)

(21) Appl. No.: 19/480,177

(22) PCT Filed: Jul. 12, 2024
(86) PCT No.: PCT/EP2024/069864

§ 371 Date: Oct. 30, 2025

(30) Foreign Application Priority Data
Sep. 22, 2023 (DE) 10 2023 209 255.7

(51) Int. Cl. G01S 13/42; G01S 7/40

(52) U.S. Cl. CPC G01S 13/42; G01S 7/40

(57) ABSTRACT

A radar device. The radar device includes a plurality of radar units, wherein each radar unit is designed to generate and emit a radar measurement signal, and wherein a computing device is configured to analyze the radar measurement signals from the radar units in combination, and wherein the computing device is configured to make a selection among the radar measurement signals from the radar units during combined analysis of the radar measurement signals.

### FIELD

The present invention relates to a radar device and to a method for analyzing radar measurement signals from a radar device.

### BACKGROUND INFORMATION

A radar device emits a radar signal which is reflected by objects in the radar channel. In the monostatic case, the reflected radar signal is received and analyzed by the same radar device in order to detect the distance, speed and angle of the reflecting objects relative to the radar device.

In the bistatic case, the reflected radar signal can also be received by a second radar device which is spatially separated from the first radar device. The distance, speed and angle of the reflected objects can be determined using the known distance between the two radar devices. The detected data are processed into reflex lists in the respective radar devices and made available, e.g., via a bus system.

A cooperative radar sensor system can consist of at least two radar sensors or of a computing unit having an extended overall antenna array consisting of sub-arrays, wherein the radar sensors or sub-arrays can be synchronized according to a synchronization concept. An exemplary radar sensor system is described in Germany Patent Application No. DE 10 2019 220 238 A1.

### SUMMARY

The present invention provides a radar device and a method for analyzing radar measurement signals from a radar device.

Preferred embodiments of the present invention are disclosed herein.

According to a first aspect, the present invention relates to a radar device. According to an example embodiment of the present invention, the radar device has a plurality of radar units, wherein each radar unit is designed to generate and emit a radar measurement signal, and a computing device that is configured to analyze the radar measurement signals from the radar units in combination, wherein the computing device is configured to make a selection among the radar measurement signals from the radar units during combined analysis of the radar measurement signals.

According to a second aspect, the present invention relates to a method for analyzing radar measurement signals from a radar device. According to an example embodiment of the present invention, radar measurement signals are generated by a plurality of radar units of the radar device. Furthermore, a combined analysis of the radar measurement signals from the radar units is carried out, wherein a selection among the radar measurement signals from the radar units is made during combined analysis of the radar measurement signals.

According to the present invention, the radar measurement signals of the radar units are selected. This is to be understood as meaning that not all radar measurement signals from the radar units are taken into account during combined analysis of the radar measurement signals. The present invention thus makes possible the use of adaptive, dynamically generated apertures in radar devices.

In order to optimally and efficiently analyze the radar measurement data from the radar units of the radar device, sensor apertures of different sizes can be used for analysis according to the available measurement points or the relative positions of the target to the radar device (e.g., the ego vehicle).

According to one example embodiment of the present invention, the radar device is a cooperative radar sensor system, wherein the radar units are individual radar sensors of the radar sensor system.

According to one example embodiment of the present invention, the radar device is an individual radar sensor, wherein the radar units are sub-arrays of antenna elements of the radar sensor. In particular, the radar device can be a radar unit having a sparse antenna aperture, preferably having sub-arrays (e.g., separated by cables).

According to one example embodiment of the radar device of the present invention, the computing device is configured to completely omit at least one radar measurement signal from a radar unit during combined analysis of the radar measurement signals or to take it into account only with respect to a subset of transmit/receive channels of the radar unit. Here, a subset is understood to mean a proper subset, which therefore does not comprise all radar units.

According to one example embodiment of the radar device of the present invention, the computing device is configured to perform an angle determination for specified angle segments and/or distance segments by combined analysis of the radar measurement signals from a specified subset of the radar units.

According to one example embodiment of the radar device of the present invention, sensor apertures of individual radar units can be assigned to a plurality of angle segments and/or distance segments simultaneously for joint analysis, e.g., according to the distance to the target, or can be segmented within a physically existing radar unit, i.e., different antennas of the same radar unit can be assigned to different angle segments and/or distance segments.

According to one example embodiment of the radar device of the present invention, the computing device is configured, if the radar measurement signals comprise a target (i.e., a target has been recognized) only for a subset of the radar units in a specific distance-velocity cell, to select, for the combined analysis, the radar measurement signals from the radar units in the subset of radar units that form a longest uninterrupted aperture. Depending on the preprocessing of the radar measurement data from the radar units, where target lists are generated from the raw data, it may be that not all radar units have identified the same measurement point, e.g., with respect to distance and speed. As a result, measurement data for a cross-sensor angle analysis are absent, and gaps or unoccupied areas (holes) are created in the aperture. Depending on which radar unit provides no information, the longest useful aperture (for example, the longest uninterrupted aperture) can be generated from the available radar measurement data and given increased value. The same procedure can also be carried out, e.g., according to the distance or angle of incidence to the target in order to avoid range migration effects due to the aperture size.

According to one example embodiment of the radar device of the present invention, the computing device is configured to recognize a misalignment of the radar units by omitting radar measurement signals from individual radar units during combined analysis. For example, misalignment recognition can be performed or the measurement results of misaligned individual sensors can be corrected by cyclic omission of radar measurement data from individual radar units from the overall aperture and verification of the radar measurement data of the remaining aperture against the omitted units.

According to one example embodiment of the radar device of the present invention, the computing device is configured to perform a calibration of the radar unit upon recognition of a misalignment of one of the radar units. This can be done using an algorithm, for example.

According to one example embodiment of the radar device of the present invention, the computing device is configured to perform a single-target estimation on the basis of a selection among the radar measurement signals and to calculate at least one quality value of the single-target estimation. The computing device is further configured to perform a combined analysis of all radar measurement signals only if at least one quality value falls below a specified threshold value. For example, in the angle analysis of distance-velocity cells that potentially contain more than one target, a quality criterion can be ascertained by using a sub-aperture having few virtual channels (i.e., by selecting radar measurement data from only some radar units), from which it can be derived whether more than one target is potentially located in the distance-velocity cell. From this criterion, it can be derived whether further analysis is worthwhile, for example a method for reducing a sidelobe level, a multi-target estimation or a more elaborate detection of targets on the spectrum of the overall aperture. As a result, the computational effort required for angle estimation can be significantly reduced.

According to one example embodiment of the radar device of the present invention, the combined analysis of all radar measurement signals comprises a single-target estimation or a multi-target estimation.

According to one example embodiment of the radar device of the present invention, the computing device is configured to perform an angle estimation during combined analysis of the radar measurement signals from the radar units. By selecting a plurality of radar units, the aperture is increased, which increases the accuracy of the angle estimation.

Further advantages, features and details of the present invention will become apparent from the following description, in which various exemplary embodiments are described in detail with reference to the figures.

### BRIEF DESCRIPTION OF THE DRAWINGS

FIG. 1 is a schematic block diagram of a radar device according to one example embodiment of the present invention.

FIG. 2 shows schematic angle/distance segments.

FIG. 3 shows an exemplary selection of radar measurement signals for a near range and a central far range.

FIG. 4 shows an exemplary selection of radar measurement signals for edge segments.

FIG. 5 is an exemplary illustration of an absence of measurement results in the radar measurement signals.

FIG. 6 is an exemplary illustration for determining a misalignment of a radar unit due to rotation.

FIG. 7 is an exemplary illustration for determining a misalignment of a radar unit due to displacements of the individual radar units relative to one another.

FIG. 8 is an exemplary illustration for determining a misalignment of a radar unit due to displacements of groups of radar units relative to one another.

FIG. 9 is an exemplary illustration of a determination of quality values.

FIG. 10 is a flow chart of a method for analyzing radar measurement signals from a radar device according to one example embodiment of the present invention.

In all figures, identical or functionally identical elements and devices are provided with the same reference signs. The numbering of method steps serves the purpose of clarity and is generally not intended to imply a specific chronological order. In particular, a plurality of method steps may also be carried out simultaneously.

### DETAILED DESCRIPTION OF EXAMPLE EMBODIMENTS

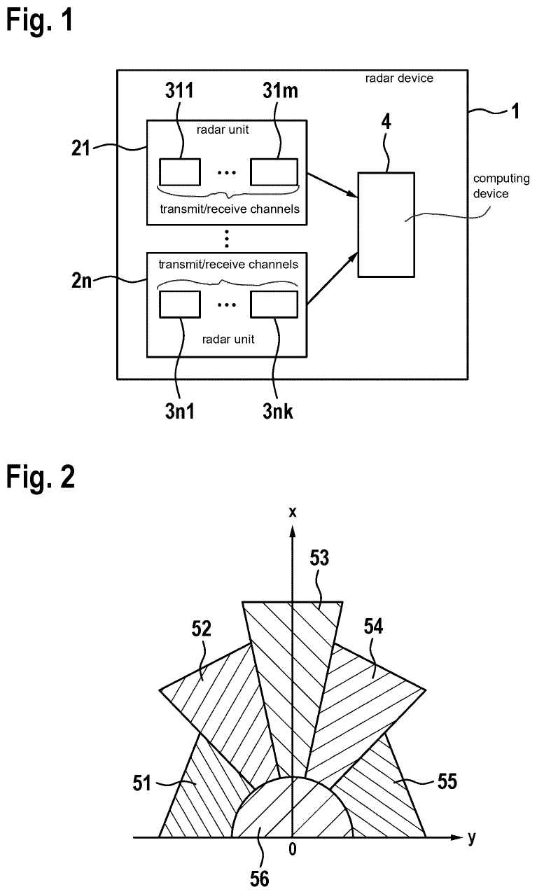

FIG. 1 is a schematic block diagram of a radar device 1 having a plurality of radar units 21 to 2n, where n denotes the total number of radar units. However, the present invention is not limited to a specific number. The radar units 21 to 2n can be arranged in a motor vehicle. The radar device 1 can be a cooperative radar sensor system, wherein the radar units 21 to 2n are individual radar sensors. The radar device 1 can also be an individual radar sensor, wherein the radar units 21 to 2n are sub-arrays of antennas of the radar sensor.

Each radar unit has a specific number of transmit/receive channels 311 to 31m, 3n1 to 3nk, where m and k denote the number of transmit/receive channels for the first radar unit 21 and the n-th radar unit, respectively. The radar units 21 to 2n can be different or identical, i.e., can in particular comprise the same or at least partially different numbers of transmit/receive channels 311 to 31m, 3n1 to 3nk.

Each radar unit 21 to 2n is designed to generate and emit a radar measurement signal. The radar measurement signals can comprise the radar data of all transmit/receive channels 311 to 31m, 3n1 to 3nk of the corresponding radar unit 21 to 2n.

The radar device 1 further comprises a computing device 4. This can be an external device or a component of one or more of the radar units 21 to 2n. The computing device 4 can be formed by components of each radar unit 21 to 2n, wherein these components can exchange data.

The computing device 4 can comprise a processor, microprocessor, integrated circuit, application-oriented circuit or the like.

The computing device 4 can further comprise at least one storage device for storing data, in particular the radar measurement data, and program instructions.

The computing device 4 receives the radar measurement signals from the radar units 21 to 2n and analyzes them.

The computing device 4 can perform a combined analysis of the radar measurement signals, for example in order to perform an angle estimation. The computing device 4 can make a selection among the radar measurement signals from the radar units 21 to 2n.

The computing device 4 can, for example, completely omit at least one radar measurement signal from a radar unit 21 to 2n during combined analysis of the radar measurement signals. The computing device 4 can also take into account only a subset of transmit/receive channels 311 to 31m, 3n1 to 3nk of the radar unit 21 to 2n.

FIG. 2 shows schematic angle and distance segments. The radar device 1 is located at the origin of a coordinate system having x and y axes. The surrounding region is divided into six segments 51 to 56, specifically a near range 56, a central far range 53 about the x-axis, and in each case two left and two right edge regions or edge segments 51, 52 and 54, 55, respectively. The present invention is not limited to a specific number of segments, i.e., the number can also be greater or less than six.

The computing device 4 can perform an angle determination for the specified angle and distance segments by combined analysis of the radar measurement signals from a specified subset of the radar units 21 to 2n.

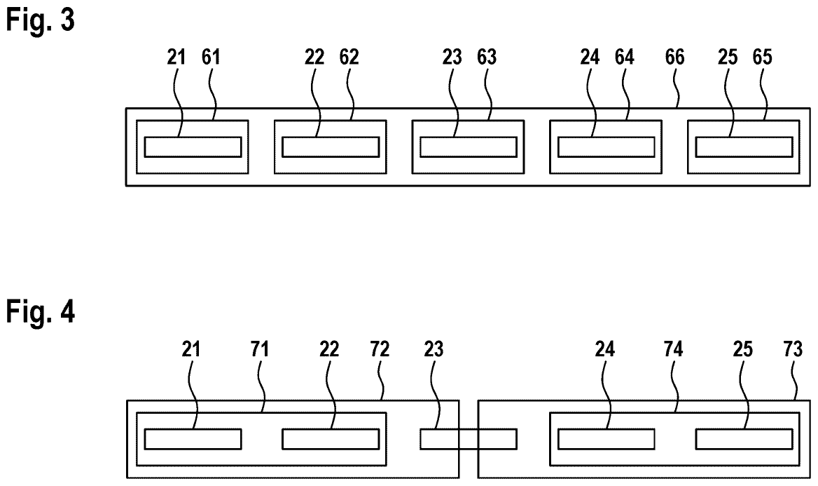

FIG. 3 shows an exemplary selection of radar measurement signals for the near range 56 and the central far range 53. In this exemplary case, there are five radar units 21 to 25, although the present invention is not limited thereto.

For the near range 56, the radar measurement signals from the radar units 21 to 25 are in each case analyzed individually (selections 61 to 65). This can, for example, already be carried out as preprocessing within the radar units 21 to 25, and is particularly useful in the near range, since the far-field condition is not satisfied there due to the size of the cooperative overall aperture.

For the central far range 53, the radar measurement signals from all radar units 21 to 25 are combined (selection 66). The central far range 53 corresponds to an angle range near boresight from a greater distance.

FIG. 4 shows an exemplary selection of radar measurement signals for the edge segments 51, 52 and 54, 55. For the outer left edge segment 51, the radar measurement signals from the two left radar units 21, 22 are combined (selection 71). For the inner left edge segment 52, the radar measurement signals from the two left radar units 21, 22 and a left half of the transmit/receive channels of the middle radar unit 23 (i.e., with respect to the antennas arranged further to the left) are combined (selection 72). For the inner right edge segment 54, the radar measurement signals from the two right radar units 24, 25 and a right half of the transmit/receive channels of the middle radar unit 23 (i.e., with respect to the antennas arranged further to the right) are combined (selection 73). For the outer left edge segment 55, the radar measurement signals from the two right radar units 24, 25 are combined (selection 74).

The edge segments 51, 52, 54, 55 are defined on the basis of the far-field condition, i.e., the minimum distance from which analysis is to be carried out, or on the basis of range migration effects along the aperture, i.e., with respect to the angle segments. The edge segments 51, 52, 54, 55 can either be defined so that no significant influences arise due to the far-field condition or range migration, or so that the resulting effects can be eliminated with acceptable effort.

An estimation of the far-field condition having the aperture A and the wavelength λ (at 77 GHz) is:

$${d}_{far} > \frac{2 {A}^{2}}{λ} .$$

For range migration along the aperture A, the following applies for the modulation bandwidth B, the speed of light c and the angle of incidence φ:

$$\pm {ϕ}_{max} < {sin}^{- 1} \frac{c}{2 BA} .$$

Based on the two estimates, a smooth transition between the apertures can also be created by defining more segments. The granularity of the relevant aperture and the resulting segments is limited only by the positioning of the virtual antenna channels of the overall aperture. Depending on the system concept and data connection, the segments can also be processed at different locations, e.g., in one of the radar units 21 to 2n, in an accumulator, or in a central unit, which can reduce the required data rates between the system components.

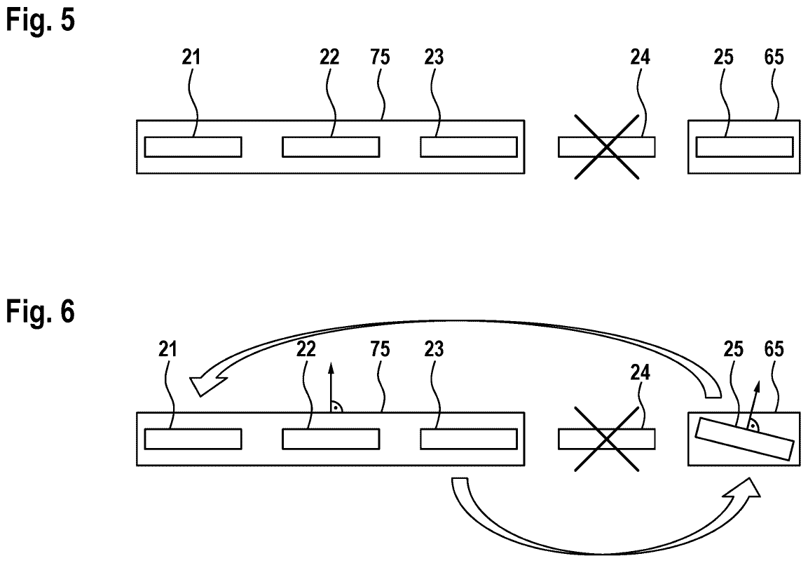

FIG. 5 is an exemplary illustration of an absence of measurement results in the radar measurement signals. Here, specific measurement data are absent in the radar measurement data of the fourth radar unit 24. For example, the radar measurement signals comprise a target only for a subset of the radar units 21 to 25 in a specific distance-velocity cell, specifically only for radar units 21 to 23 and 25. Since not all radar units 21 to 25 can provide data for the joint angle estimation (e.g., no target was found for the fourth radar unit 24 in a specific distance-velocity cell), data in order to perform a joint angle estimation over the defined aperture are absent. This leads to holes in the aperture.

One reason for this is, e.g., targets having a strongly angle-dependent backscatter cross section or a high degree of preprocessing in which data have already been discarded.

Instead of aborting the angle analysis and, if applicable, reverting to the results of the individual radar units 21 to 25, an angle estimation having a dynamic aperture can be performed.

For this purpose, the computing device 4 selects the radar measurement signals from the radar units 21 to 23 and 25 of the subset of radar units 21 to 23 and 25 for the combined analysis which form a longest uninterrupted aperture (sub-aperture). In this case, these are the first three radar units 21 to 23, corresponding to the selection 75. This sub-aperture can be segmented on a sensor-by-sensor basis, or within the radar units 21 to 25, if the necessary data are available. A mask can be created on the basis of the available data of the overall aperture, which is used to cut out the relevant region from the steering matrix that is used for angle estimation, which is then applied to the measurement data for the angle analysis.

FIG. 6 is an exemplary illustration for determining a misalignment of a radar unit 21 to 25 due to rotation. In this case, the fifth radar unit 25 is rotated, i.e., misaligned.

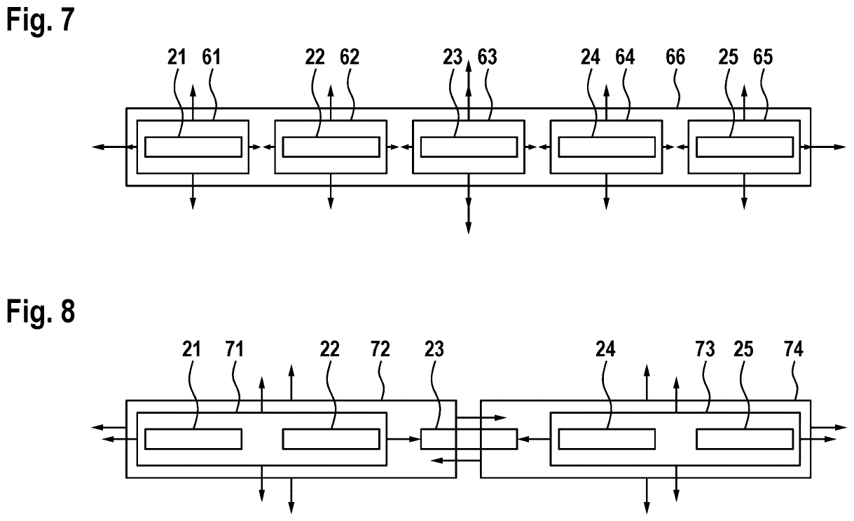

FIG. 7 is an exemplary illustration for determining a misalignment of a radar unit 21 to 25 due to a translation, wherein the radar units 21 to 25 in each case are individually displaced relative to one another and are individually validated.

FIG. 8 is an exemplary illustration for determining a misalignment of a radar unit due to a lateral displacement in the x-, y- or z-direction, wherein groups of radar units 21 to 25 are displaced relative to other groups of radar units 21 to 25 or are validated on different apertures.

The computing device 4 can, by omitting radar measurement signals from individual radar units 21 to 25 during combined analysis, recognize a misalignment of the radar units 21 to 25 in one of the cases shown in FIG. 6 to 8. By analyzing the remaining aperture without the radar unit 21 to be checked against the radar units 21 to 25 to be checked, a misalignment can be recognized.

If a target, preferably in the far field, is detected in the data of all radar units 21 to 25, a misalignment of the individual radar unit 21 to 25 or of any sub-aperture can be detected by generating different sub-apertures, e.g., in each case by omitting one radar unit 21 to 25. Additionally, recalibration can be carried out.

The misalignments can be corrected mathematically and/or recalibrated. A distinct target can be selected which is detected by the sub-aperture under investigation and by the remaining aperture, or by each radar unit 21 to 25 of the remaining aperture.

For misalignments in angle or due to rotation, an angle estimation is performed for the remaining aperture and the individual sensor, or for the sub-aperture to be checked. By comparing and validating the two estimated angles, the misalignment can be detected and/or quantified. This relative misalignment can be verified and validated by permutation of the assembled sub-apertures, and it can be inferred which radar unit or sensor, or which sub-aperture, is actually misaligned. Using appropriate algorithms, the quantified misalignment can be converted into, e.g., calculated correction factors and/or a calibration matrix can be adjusted and/or a misalignment can be reported to the user.

By using correction factors or adjusting the calibration matrix, the measurement result of the radar unit or the misaligned individual sensor or the misaligned sub-aperture can be corrected and thus a deterioration of the measurement results of the overall aperture can be prevented.

In the case of a rotational misalignment, the two spatial angles of the radar units 21 to 2n are detuned, and detection or correction can be carried out in the two angular directions. When detecting lateral misalignment or misalignment in the z-direction, all sub-apertures can be assembled and permuted, as is the case with the detection of tilt and rotation. For all sub-apertures, the measurement parameters of distance, speed and the two spatial angles are recorded and, e.g., validated against one another on the basis of a distinct target that appears in all radar measurement data or measurement data from sub-apertures.

For example, with the aid of the spatial angles and the distance, all targets can be plotted in a Cartesian three-dimensional grid, and in this way any displacements along the x-, y-, and z-axes for specified radar units or sub-apertures can be detected and their measurement results can be corrected accordingly.

If a misalignment of one of the radar units 21 to 25 is recognized, the computing device 4 can perform a calibration of the radar unit 21 to 25.

In the example of FIG. 6, the radar measurement data of the fifth radar unit 25 (aperture or selection 65) can be additionally analyzed in order to, e.g., validate a result on the basis of the selection 72.

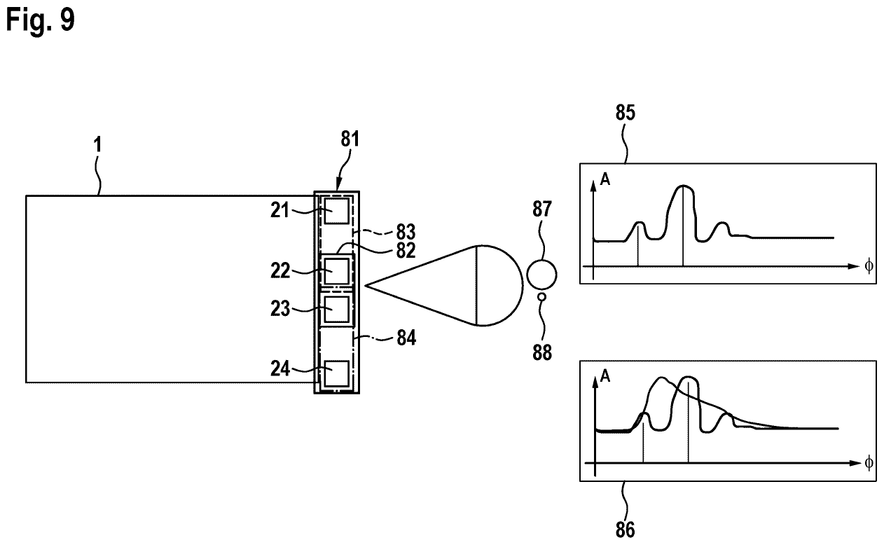

FIG. 9 is an exemplary illustration of a determination of quality values. The computing device 4 can perform an angle estimation on the basis of a selection among the radar measurement signals and calculate at least one quality value of the angle estimation. The computing device 4 can be configured to perform a combined analysis of all radar measurement signals only if the at least one quality value falls below a specified threshold value.

According to one embodiment of the radar device, the combined analysis of all radar measurement signals comprises a multi-target estimation and/or methods for reducing sidelobe levels. Whether such a combined analysis on an overall aperture 81 (comprising all radar units 21 to 24) is performed at all is determined by a benefit assessment on smaller, computationally less intensive, virtual sub-apertures 82, 83, 84.

For large antenna apertures having many virtual channels, angle estimation and especially multi-target estimation are highly complex. In addition, the sparsity of the overall aperture 81 gives rise to very high sidelobe levels, which can be suppressed by algorithms prior to multi-target estimation in order to be able to distinguish two or more targets having significantly different radar backscatter cross sections that lie in a distance-velocity cell, and to prevent weaker targets from being masked by the sidelobes of stronger ones.

Both the multi-target estimation and algorithms for reducing the sidelobe level are highly computationally intensive and should only be applied if they are likely to be successful. Therefore, sub-apertures 82, 83, 84 of the corresponding virtual bistatic radar units 21 to 24, or individual sensors 21 to 24, or all virtual apertures consisting of more than two individual sensors 21 to 24 can be used to determine or estimate the number of targets in the angular spectrum, and to decide on the use of multi-target estimators or on the selection criteria for targets (e.g., decision thresholds), and on the use of methods for reducing the sidelobe level on the overall aperture 81.

An example of a multi-target estimator is, e.g., the 2-target deterministic maximum likelihood estimator. Decision criteria can be, for example, the choice of the level of the decision threshold value above which a peak in the angular spectrum is recognized as a target. Methods for reducing the sidelobe level can be so-called “compressed sensing” methods, such as the “iterative method with adaptive threshold” (IMAT), CLEAN or the like.

For the decision as to whether the use of reduction techniques, multi-target estimators and more complex detection methods on the computationally intensive overall aperture 81 is useful, quality criteria are determined on the computationally less intensive sub-apertures, e.g., the magnitude of the correlation factor (Bartlett estimator) for the main angle. The profile 85 of an amplitude A as a function of the angle φ is plotted for the overall aperture 81.

If this angular quality value, e.g., the correlation value or another quality criterion, lies below a specific threshold value, i.e., the probability that only a single target is present in the spectrum is low, or if two targets are detected directly, it is highly likely that a plurality of targets 87, 88 are present at different angles in this distance-velocity cell. Profiles 86 of the amplitude A as a function of the angle φ are plotted for the overall aperture 81 and for a smaller sub-aperture 82.

The computing device 4 can then decide whether a downstream reconstruction of the finely resolved angles, the use of multi-target estimators, the adjustment of decision criteria or the detection technique based on the entire aperture is justified, and whether the computational effort for reducing the sidelobe level is worthwhile, or whether a single-target estimator on the full aperture is already sufficient.

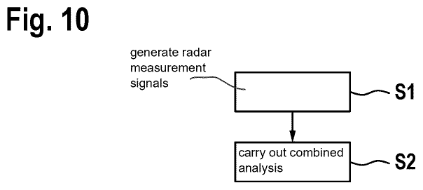

FIG. 10 is a flow chart of a method for analyzing radar measurement signals from a radar device 1. The method can be performed using the radar device 1 described above.

In a first step S1, radar measurement signals are generated by a plurality of radar units 21 to 2n of the radar device 1.

In a second step S2, a combined analysis of the radar measurement signals from the radar units 21 to 2n is carried out, wherein a selection among the radar measurement signals from the radar units 21 to 2n is performed during combined analysis of the radar measurement signals.

At least one radar measurement signal from a radar unit can be completely omitted during combined analysis of the radar measurement signals, or only a subset of transmit/receive channels of the radar unit can be taken into account.

An angle determination for specified angle segments and/or distance segments can be performed by combined analysis of the radar measurement signals from a specified subset of the radar units.

Furthermore, radar units having the longest uninterrupted aperture can be selected for combined analysis.

Furthermore, misalignment of the radar units can be recognized and corrected if applicable.

Furthermore, an angle estimation can be performed on the basis of a selection among the radar measurement signals, and at least one quality value of the angle estimation can be calculated. A combined analysis of all radar measurement signals is only performed if at least one quality value falls below a specified threshold value.

1-12. (canceled)

13. A radar device, comprising:
a plurality of radar units, wherein each of the radar units is configured to generate and emit a radar measurement signal; and
a computing device configured to analyze the radar measurement signals from the radar units in combination, wherein the computing device is configured to make a selection among the radar measurement signals from the radar units during a combined analysis of the radar measurement signals.

14. The radar device according to claim 13, wherein the computing device is configured to completely omit at least one of the radar measurement signals from one of the radar units during the combined analysis of the radar measurement signals or to take the at least one of the radar measurement signals into account only with respect to a subset of transmit/receive channels of the radar unit.

15. The radar device according to claim 14, wherein the computing device is configured to perform an angle determination for specified angle segments and/or distance segments by combined analysis of the radar measurement signals from a specified subset of the radar units.

16. The radar device according to claim 13, wherein the computing device is configured to select for the combined analysis, when the radar measurement signals include a target only for a subset of the radar units in a specific distance-velocity cell, the radar measurement signals from the radar units of the subset of radar units that form a longest uninterrupted aperture.

17. The radar device according to claim 13, wherein the computing device is configured to recognize a misalignment of the radar units by omitting radar measurement signals from individual radar units during combined analysis.

18. The radar device according to claim 17, wherein the computing device is configured to perform a calibration of a radar unit upon recognition of a misalignment of one of the radar units.

19. The radar device according to claim 13, wherein the computing device is configured to perform a single-target estimation based on a selection among the radar measurement signals and to calculate at least one quality value of the single-target estimation, wherein the computing device is further configured to perform a combined analysis of all radar measurement signals only when the at least one quality value falls below a specified threshold value.

20. The radar device according to claim 19, wherein the combined analysis of all radar measurement signals includes a multi-target estimation.

21. The radar device according to claim 13, wherein the computing device is configured to perform an angle estimation during combined analysis of the radar measurement signals from the radar units.

22. The radar device according to claim 13, wherein the radar device is a cooperative sensor system, and wherein the radar units are radar sensors.

23. The radar device according to claim 13, wherein the radar device is a radar sensor, and wherein the radar units are sub-arrays of antenna elements of the radar sensor.

24. A method for analyzing radar measurement signals from a radar device, comprising the following steps:
generating radar measurement signals using a plurality of radar units of the radar device; and
performing a combined analysis of the radar measurement signals from the radar units, wherein a selection among the radar measurement signals from the radar units is made during the combined analysis of the radar measurement signals.
